(19) United States
(12) Patent Application Publication
(10) Pub. No.: US 2019/0077072 A1
(43) Pub. Date: Mar. 14, 2019

(54) THREE-DIMENSIONAL (3D) PRINTING AND INJECTION MOLDING CONDUCTIVE FILAMENTS AND METHODS OF PRODUCING AND USING THE SAME

(71) Applicant: Duke University, Durham, NC (US)

(72) Inventors: Benjamin Wiley, Durham, NC (US); Shengrong Ye, Durham, NC (US)

(21) Appl. No.: 16/126,515

(22) Filed: Sep. 10, 2018

Related U.S. Application Data
(60) Provisional application No. 62/556,555, filed on Sep. 11, 2017.

(51) Int. Cl. B29C 64/118; H01B 1/22; B33Y 10/00; B33Y 70/00

(52) U.S. Cl. CPC B29C 64/118; H01B 1/22; B29K 2505/10; B33Y 70/00; B33Y 10/00

(57) ABSTRACT

Three-dimensional (3D) printing and injection molding conductive filaments and methods of producing and using the same are disclosed. According to an aspect, a conductive filament for 3D printing includes a material comprising polymer. The conductive filament also includes anisotropic conductive particles dispersed within the material.

### CROSS REFERENCE TO RELATED APPLICATION

This application claims priority to U.S. Provisional Patent Application No. 62/556,555, filed Sep. 11, 2017, and titled CONDUCTIVE 3D PRINTING FILAMENTS AND METHODS OF MAKING AND USING SAME, the content of which is incorporated herein by reference in its entirety.

### TECHNICAL FIELD

The presently disclosed subject matter relates generally to three-dimensional (3D) printing and injection molding. Particularly, the presently disclosed subject matter relates to 3D printing and injection molding conductive filaments and methods of producing and using the same.

### BACKGROUND

3D printing is a process in which material is joined or solidified to create a 3D object, with material being added together. It may be implemented under computer control and is often used in both rapid prototyping and additive manufacturing. Objects can be made of many different shapes and geometries. Such objects can be designed by computer to create digital model data of the object. The data may be used as a plan for a 3D printer, 3D pen, and robotic arms for 3D printing, to create the object. Fused filament fabrication (FFF) is a type of 3D printing technique that extrudes plastic or polymer material through a nozzle to form an object.

Emerging 3D printing techniques have the potential to drastically reduce the cost and energy associated with the production of electronic devices. Perhaps more importantly, it has the potential to enable rapid prototyping of circuits, electronic and radiofrequency (RF) components and their printing on demand, as well as realization of new functional structures that are not possible with conventional technologies, similar to what 3D printing has done for structural objects. Finally, fully printable electronics may enable the expansion of next-generation electronics away from silicon wafers to substrates that are less expensive, larger in area, and/or flexible, or even stretchable.

Commercial 3D printers have enabled hobbyists and inventors to quickly produce inanimate, physical objects. There are efforts to bring similar capabilities to the printing of electronics, bus this work is in its early states and it is not currently possible to print anything but conductive lines with 3D printers. For example, to print a conductive material there are currently two options. First, silver inks can be printed at near-bulk conductivity (5×10⁻¹ ohm m for ink vs. 1.6×10⁻⁸ ohm m for bulk) using silver paste printers like the Voxel8, but this specialized printer may be too expensive for many individuals. Meanwhile, it is challenging to form freestanding structures with the liquid link. Second, conductive carbon-filled polymers are commercially available and can be readily printed on most low-cost 3D printers. However, these materials have a relatively high volume resistivity (greater than 10⁻² ohm m) and are impractical for high-to-medium voltage applications, as the heat generated can drastically reduce circuit lifetime. In order to perform rapid prototyping of circuitry and electronics at both low cost and high quality, improved materials are needed.

Injection molding is a manufacturing technique for producing components or parts by injecting molten material into a mold. Injection molding can be performed with a variety of materials including metals, glasses, elastomers, and most commonly thermoplastic and thermosetting polymers. In this technique, material for the component is fed into a heated barrel, mixed, and injected into a mold cavity, where it cools and hardens to the configuration of the cavity. Although various useful advancements have been made, there is a desire to provide improved materials for injection molding, such as improved materials for creating conductive components.

### BRIEF DESCRIPTION OF THE DRAWINGS

Having thus described the presently disclosed subject matter in general terms, reference will now be made to the accompanying Drawings, which are not necessarily drawn to scale, and wherein:

FIG. 1 is an image of an example copper-silver (Cu—Ag) nanowire filament in accordance with embodiments of the present disclosure;

FIGS. 2 and 3 show a scanning electron microscopy (SEM) image and energy dispersive x-ray spectroscopy (EDS) image, respectively, of the Cu—Ag nanowires within the filament shown in FIG. 1;

FIG. 4 is a flow diagram of a method for producing conductive filament for 3D printing in accordance with embodiments of the present disclosure;

FIGS. 5A-5C depict steps in an example method for producing a metal nanowire-based filament in accordance with embodiments of the present disclosure;

FIG. 6A is a graph showing stability tests (n=3) of Cu—Ag nanowires with varying mole ratios of Ag to Cu (dry-oven texts at 150 degrees C.);

FIG. 6B is a graph showing stability tests (n=3) of Cu—Ag nanowires with varying mole ratios of Ag to Cu (humidity chamber tests at 85 degrees C. and 85% RH);

FIG. 7A is a graph showing resistivity of filament composites containing various Ag and Cu fillers at different volume percent (vol %);

FIG. 7B are camera images of the composite films that show the greater surface roughness of nanowire composites with high loadings of nanowires;

FIG. 7C are micro-CT images of filament composite films showing areas of high and low density of metal filler;

FIG. 8A is an image showing filament production that started with a mixture of Cu—Ag nanowires and PCL dissolved in DCM;

FIG. 8B is an image showing the drawing of the solution of FIG. 8A and that it created a solidified composite which was cut into uniform pellets;

FIG. 8C is an image that shows extrusion through a Filabot to form the filament;

FIG. 8D is an image showing a coil of filament produced from the Filabot of FIG. 8C; and

FIG. 8E is an SEM image showing that the Cu—Ag nanowires were evenly distributed throughout the filament at this volume fraction and length scale.

### SUMMARY

Disclosed herein are 3D printing and injection molding conductive filaments and methods of producing and using the same. According to an aspect, a conductive filament includes a material comprising polymer. The conductive filament also includes anisotropic conductive particles dispersed within the material.

According to another aspect, a method for producing conductive filament includes providing a material comprising polymer. The method also includes dispersing a plurality of anisotropic conductive particles within the material.

According to another aspect, a method for 3D printing and injection molding includes providing a conductive filament comprising a plurality of anisotropic conductive particles dispersed with a polymer material. The method also includes using a 3D printer to deposit portions of the filament in accordance with a predetermined plan for building a conductive structure.

### DETAILED DESCRIPTION

The following detailed description is made with reference to the figures. Exemplary embodiments are described to illustrate the disclosure, not to limit its scope, which is defined by the claims. Those of ordinary skill in the art will recognize a number of equivalent variations in the description that follows. For the purposes of promoting an understanding of the principles of the present disclosure, reference will now be made to various embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Unless otherwise defined, all technical terms used herein have the same meaning as commonly understood by one of ordinary skill in the art to which this disclosure belongs.

Articles “a” and “an” are used herein to refer to one or to more than one (i.e. at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

As referred to herein, 3D printing is any of various techniques in which material is joined or solidified under computer control to create a 3D object. An example 3D printing technique is fused filament fabrication.

In accordance with embodiments of the present disclosure, conductive particle-filled or metal-filled polymer composite in pellet shape (e.g., cylindrical, spherical, oval shapes, etc.) can be used for injection molding. Two example ways to make pellets include, but are not limited to, (1) pelletization of the filler-polymer mixture (the mid-product before filament extrusion); and (2) chopped filament.

As referred to herein, “fused filament fabrication” is a 3D printing process that uses a continuous filament of suitable polymer or thermoplastic material for feeding from a coil, through a moving, heated printer extruder head. Molten filament is forced out of the print head's nozzle and is deposited on the growing workpiece in accordance with a predetermined plan. The head is moved, under computer control, to define the printed shape. The head may move in layers, moving in two dimensions to deposit one horizontal plane at a time, before moving slightly upwards to begin a new slice. The speed of the extruder head may also be controlled, to stop and start deposition and form an interrupted plane without stringing or dribbling between sections. A fused filament fabrication printer is a 3D printer configured for fused filament fabrication.

A model may be used for providing a 3D printer with a plan for building a structure. In accordance with embodiments of the present disclosure, a filament as described herein may be used by the 3D printer to deposit portions of the filament in accordance with a predetermined plan for building a conductive structure. FDM may begin with a software process which uses a STereoLithography (STL) file. A computing device having one or more processors and memory may be configured to implement the FDM process. FDM may include mathematically slicing and orienting a model for the build process. The model or structure is produced by extruding small strings of molten material to form layers as the material hardens immediately after extrusion from the nozzle.

As referred to herein, injection molding is a manufacturing technique for producing components or parts by injecting molten material into a mold. Injection molding can be performed with a variety of materials including metals, glasses, elastomers, and most commonly thermoplastic and thermosetting polymers. In this technique, material for the component is fed into a heated barrel, mixed, and injected into a mold cavity, where it cools and hardens to the configuration of the cavity.

As referred to herein, a conductive particle is any particle having an ability to conduct electricity. Example conductive particles include, but are not limited to, nanowires, microwires, flakes, rods, metal core-shell structures, dendrites, and the like. Example metal core-shell structures include, but are not limited to, copper-silver, aluminum-silver, and the like. Conductive particles may be made of entirely or at least partially of, for example, silver, gold, copper, nickel, aluminum, platinum, iron, zinc, and metal alloys and eutectics including alloys of copper, silver, zinc, nickel, gallium, indium, antimony, tin, lead, and the like. The conductive particles may have a silver to copper molecular ratio of between about 0.01 and about 0.5.

As referred to herein, the term “anisotropic” can mean anisotropy of physical shape or geometry. As opposed to isotropic particles, the anisotropic particles are not spherical and the size of an anisotropic particle is not equal for all directions. Thus, the ratio of the long axis to the short axis of an anisotropic particle is called aspect ratio. Anisotropic particles are typically planar, ellipsoidal, cylindrical, conical, and the like.

Primary conductive particles are those anisotropic particles mentioned previously. Inclusion particles, or the secondary conductive particles, are typically smaller than the primary conductive particles in size. They can be shaped, for example, as a spherical, oval, rod, disk, and the like.

In accordance with embodiments, a conductive filament for 3D printing is provided. The conductive filament may include a material entirely or partially made of polymer. Further, the conductive filament may include multiple, anisotropic conductive particles dispersed with the material. The conductive particles may be metallic particles dispersed in a polymer matrix. The filament may be substantially cylindrical in shape and size for use by a 3D printer. In an example, the filament may have a diameter of between about 0.5 millimeters (mm) and 10 mm. In another example, the conductive particles may be nanowires, microwires, flakes, rods, metal core-shell structures, dendrites, the like, and combinations thereof. The conductive particles may, for example, be made of silver, gold, copper, metal allow, bronze, brass, the like, and combinations thereof. Further, for example, the conductive particles may be metal core-shell structures such as, for example, copper-silver, aluminum-silver, or the like. In examples, a size range of a smallest conductive particle among the conductive particles dispersed in the material may be between about 1 nm and about 200 microns. In other examples, a size range of a largest conductive particle among the conductive particles dispersed in the material may be between about 100 nanometers and 400 microns. Example polymers for use as the material for the filament include, but are not limited to, poly lactic acid, polyethylene terephthalate (PETG), polystyrene, acrylic butyl styrene, nylon, polycarbonates (PC), acrylonitrile styrene acrylate, polycarbonate/acrylonitrile butadiene styrene (PC/ABS), polyetheretherketone (PEEK), polyetherimide, and thermoplastic polymers, glass fiber-reinforced polymer composites, carbon fiber-reinforced composites, the like, and combinations thereof. A nanowire-based 3D printing filament may have, for example, a resistivity of about 6×10⁻⁵ ohm m. The conductivity range of the polymer is greater than 10³ Siemens per meter (S/m). A volume fraction of the conductive particles is between about 1% and about 80%. The conductivity of the polymers may have a uniformity of conductivity within 20% difference per unit length or area.

The density of dispersion of conductive or metallic particles can be of any suitable amount. For example, the density range can be between about 1 g/cm³ and about 9 g/cm³.

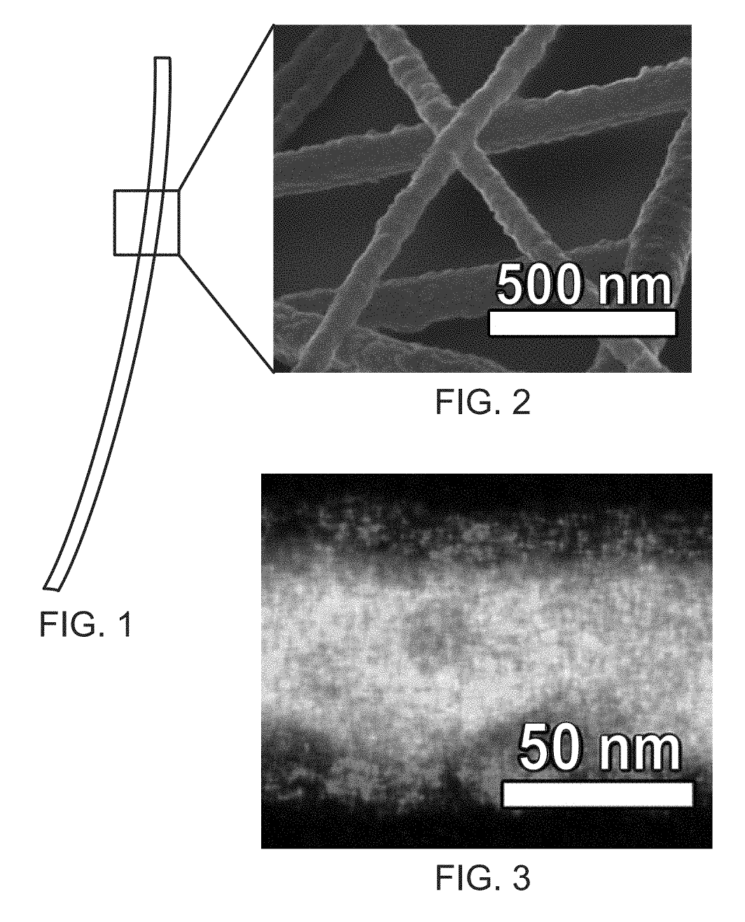

FIG. 1 shows an image of an example copper-silver (Cu—Ag) nanowire filament in accordance with embodiments of the present disclosure. FIGS. 2 and 3 show a scanning electron microscopy (SEM) image and energy dispersive x-ray spectroscopy (EDS) image, respectively, of the Cu—Ag nanowires within the filament shown in FIG. 1. The use of metal nanowires as the conductive filler can minimize the amount of metal necessary to achieve high conductivity. Although the conductive filament shown here was made with Ag-coated copper nanowires, other metal nanowires (e.g. silver nanowires), metal core-shell nanowires, metal alloy nanowires, or particles with anisotropic shapes (microwires, flakes, rods, dendrites, or others) and sizes, may be used as conductive fillers to achieve high conductivity. In some embodiments, the metallic particles may include (i) any single metals such as silver, gold, copper, and the like and combinations thereof; (ii) metal core-shell structures such as copper-silver, aluminum-silver, and the like and combinations thereof; and/or (iii) metal alloys such a bronze, brass, and the like and combinations thereof.

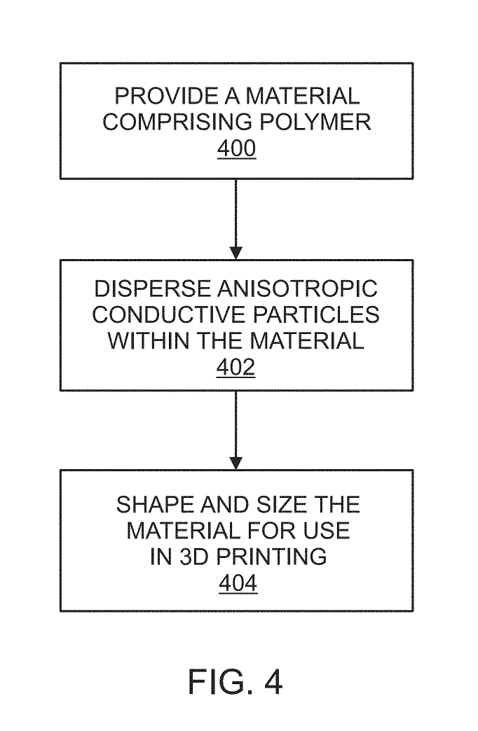

FIG. 4 illustrates a flow diagram of a method for producing conductive filament for 3D printing in accordance with embodiments of the present disclosure. Referring to FIG. 4, the method includes providing 400 a material comprising polymer. Example polymers includes, but is not limited to, poly lactic acid, acrylic butyl styrene, nylon, polycarbonates, acrylonitrile styrene acrylate, polyetherimide, thermoplastic polymer, the like, and combinations thereof.

The method of FIG. 4 includes dispersing 402 anisotropic conductive particles within the material. Further, the method of FIG. 4 includes shaping and sizing 404 the material for use in 3D printing. In an example, nanowires are mixed with solvent and a polymer suitable for 3D printing, such as polylactic acid (PLA), acrylic butyl styrene, nylon, polycarbonates, acrylonitrile styrene acrylate, polyetherimide, and other thermoplastic polymers that can be used for 3D printing. Alternatively, for example, the conductive filament can be produced by blending the conductive fillers with the polymer pellets on a twin-screw compounder and then by extruding to form filaments with a single-screw extruder. The conductive filament may be shaped, for example, to be substantially cylindrical. Further, the material can be sized to have a diameter of between about 0.5 mm and 10 mm, or any other suitable size.

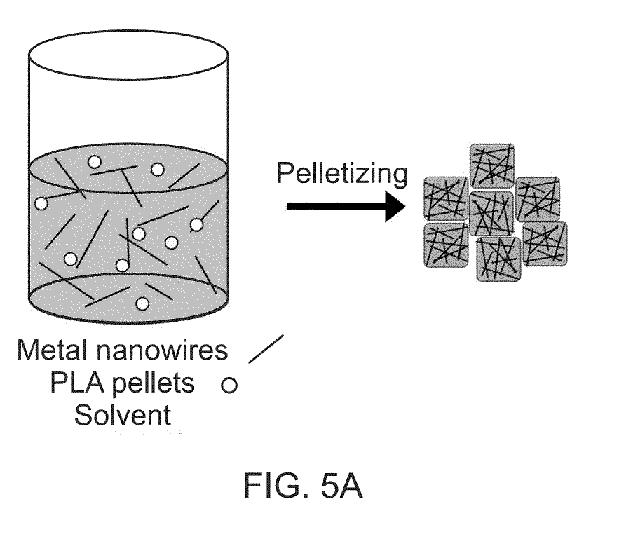

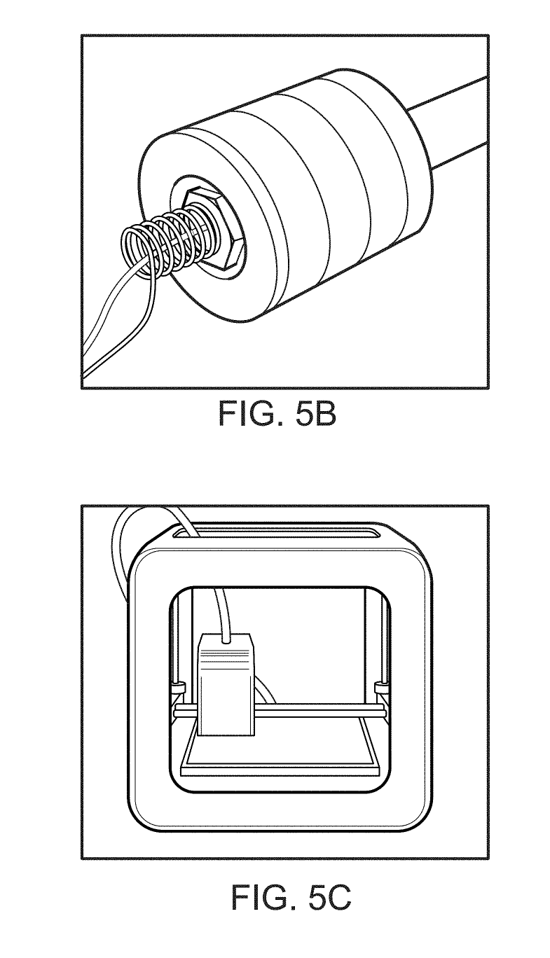

FIGS. 5A-5C depict steps in an example method for producing a metal nanowire-based filament in accordance with embodiments of the present disclosure. Referring to FIG. 5A, the figure depicts an illustrates of a container 500 containing nanowires 502 mixed with solvent and a desired polymer 504 suitable for 3D printing, such as polylactic acid (PLA), acrylic butyl styrene, nylon, polycarbonates, acrylonitrile styrene acrylate, polyetherimide, and other thermoplastic polymers used for 3D printing. This step may be followed by evaporation into nanowire-polymer composite pellets 506. Alternatively, the conductive filament may be produced by blending the conductive fillers with the polymer pellets on a twin-screw compounder and then by extruding to form filaments with a single-screw extruder, as shown in the image shown in FIG. 5B. In a subsequent step, the filament may be printed by any type of fused filament fabrication 3D printers. For example, FIG. 5C is an image of a 3D printer that may be utilized for 3D printing by depositing portions of the filament in accordance with a predetermined plan for building a conductive structure.

In accordance with embodiment, an example method for producing conductive filament for 3D printing includes synthesizing copper nanowires via an aqueous reaction. The initial solution may use Cu(NO₃)₂, ethylenediamine (EDA), and sodium hydroxide, which are stirred and heated to 50 degrees C. Subsequently, hydrazine may be stirred into the solution, and may be left to sit for 90 minutes to grow wires. The wires may subsequently be transferred into a storage solution of water, diethylhydroxylamine (DEHA), and polyvinylpyrrolidone (PVP). From this solution, the copper wires may subsequently be coated with silver through an aqueous reaction. Copper nanowires may be added to a solution also containing ascorbic acid and PVP, and stirred. Subsequently, a solution of AgNO₃ may be injected into the reaction solution, where it may be reduced by ascorbic acid and coats Ag on the Cu nanowires. After ten minutes of stirring, the solution may subsequently be rinsed three times with methanol in order to remove excess reactants and water. Subsequently, it can be rinsed twice with dichloromethane (DCM) into a final solution of Cu—Ag nanowires and DCM. PLA pellets may be added into the solution, and may be left to dissolve for approximately one hour. After dissolution, the solution may be poured into a glass dish and allowed to air dry. After drying, the polymer film may then be shredded into flakes, and may be sent into a polymer extruder to be processed into a filament that is capable of being 3D printed. In some embodiments, the filament comprises a resistivity in the range of about 1×10⁻⁸ to about 1 ohm m. In certain embodiments, the filament comprises a diameter of about 1.75 mm and resistivity of about 6×10⁻³ ohm cm.

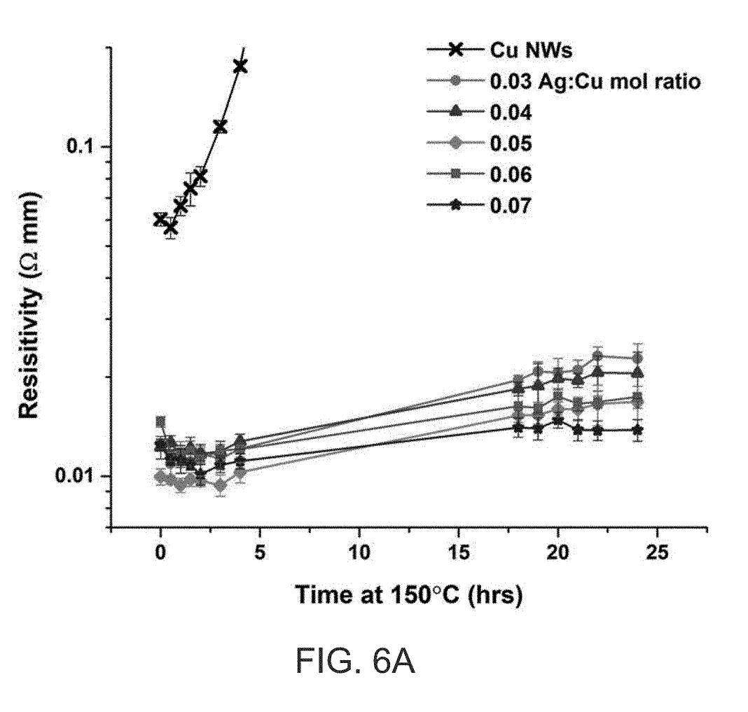

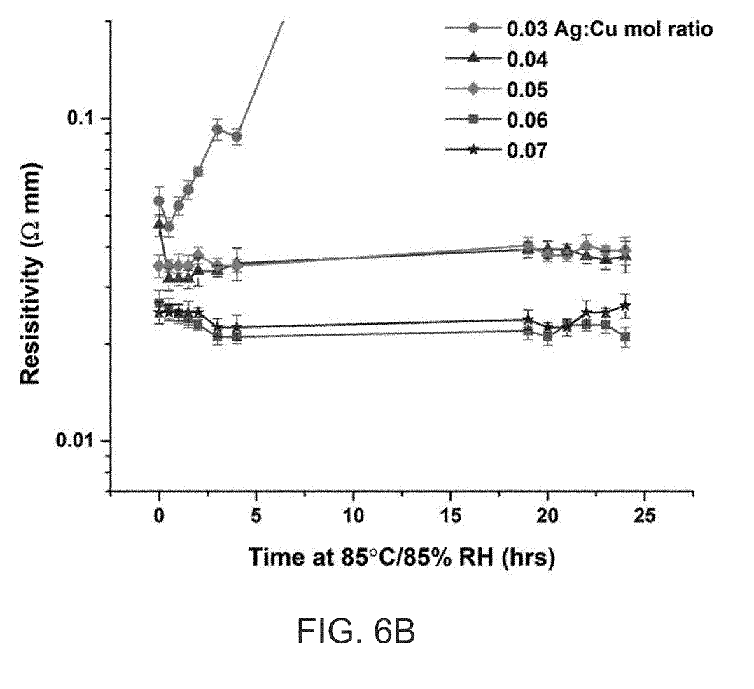

Experiments were conducted to determine a desired amount of Ag coating to produce stable and conductive nanowires, copper nanowires were coated with silver at Ag:Cu mole ratios between 0.01 and 0.5. The Cu—Ag nanowires where then suspended in a nitrocellulose ink and drop-casted into thin films in wells created by double-sided tape. After heating at 150 degrees C. for 24 hours, the graph of FIG. 6A shows the resistivity of bare copper nanowires quickly increased after 1 hour until they were not conductive. Cu—Ag nanowires with a 0.03 Ag:Cu mole ratio displayed an insignificant increase in resistivity, and increasing the Ag coating did not result in further improvement in stability. However, when exposed to conditions of 85 degrees C. with 85% relative humidity (RH) for over 24 hours, the sample coated with 0.03 Ag:Cu became nonconductive after 1 hour (see the graph of FIG. 6B). Samples with 0.04-0.07 Ag:Cu were stable after 25 hours. A minimal amount of Ag coating (greater than 0.04 Ag:Cu) is necessary to protect the nanowires from oxidation. Beyond this amount there is a negligible decrease in the resistivity of the films.

The mol ratio of 0.04 Ag:Cu corresponds to a shell thickness of about 3 nm, which was calculated from the mol ratio and the average diameter of the copper nanowires before coating. Measurement of the Ag shell from an EDS measurement map suggested a shell thickness of 5-6 nm, which is comparable to the calculated value of 3 nm. The EDS shell thickness is likely larger because the image represents 2D projection of the pentagonal nanowire, making precise measurement of the shell thickness very difficult. It is noted that the thickness of silver needed for protecting the nanowires may be roughly the same for the two nanowire diameters (240 vs. 79 nm). However, when exposed to 85% RH/85 degrees C., the sheet resistance of the Cu—Ag nanowires increased twofold after 24 hours, unlike our results which showed no change. Additionally, since the diameter of copper nanowires disclosed herein is 2.5× greater, a similar shell thickness and oxidation resistance can be achieved using 73% less Ag relative to Cu.

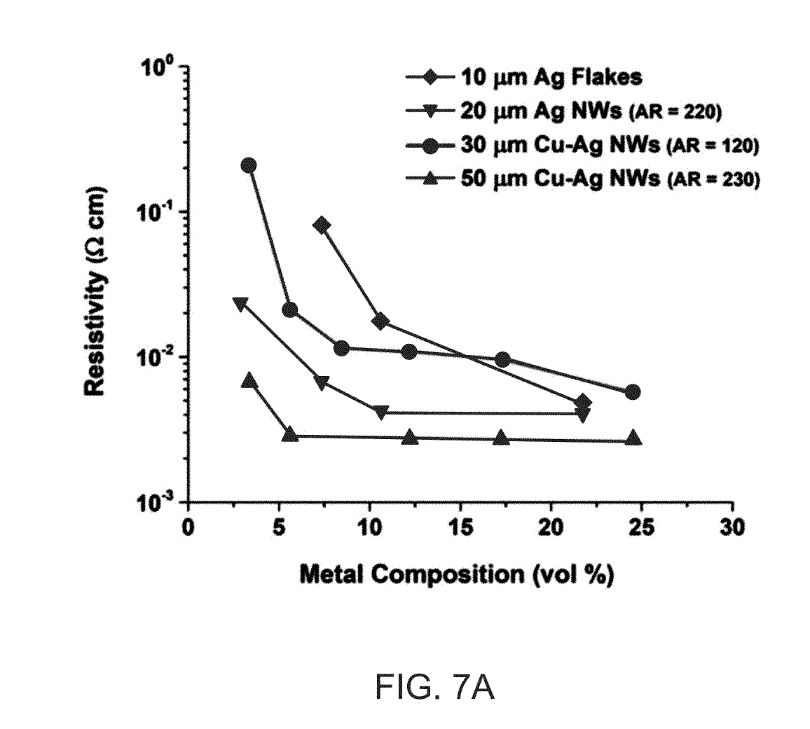

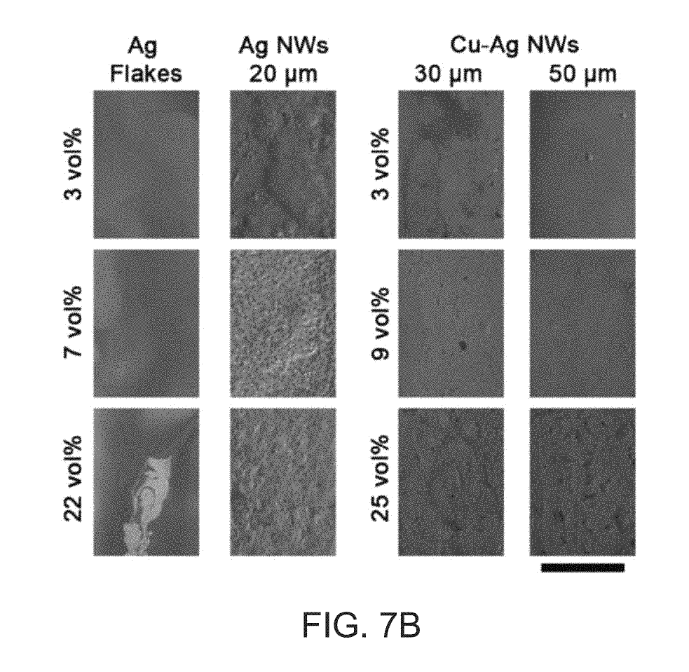

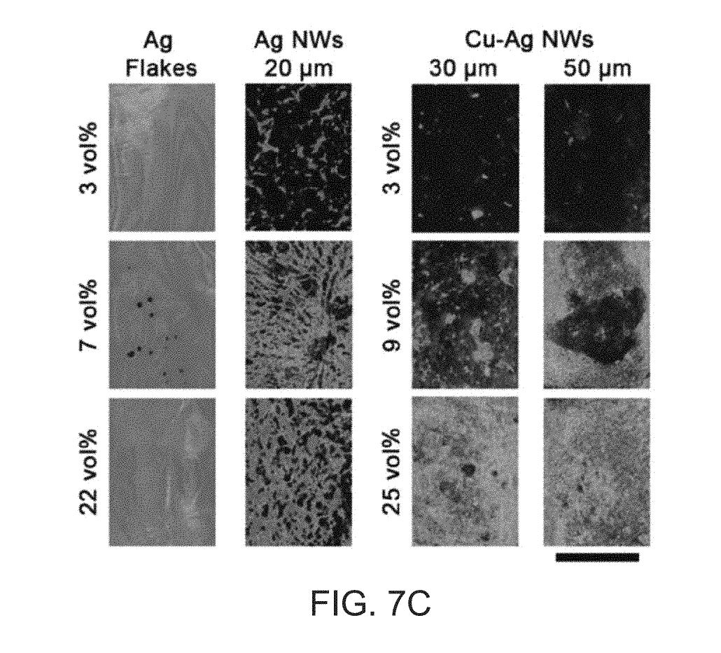

Based on previous studies of the effect of aspect ratio on conductivity of nanowire networks, it may be expected that metal nanowires with higher aspect ratios can result in a more conductive filament at a lower volume percent of filler. To test this hypothesis, nanowire-PCL composites with 3-25 vol % loading of 30 and 50-μm-long Cu—Ag NWs, 3-22 vol % 10 μm Ag flakes, and 3-22 vol % of 20-μm-long Ag NWs were created. As shown in FIG. 7A, the resistivity of all samples initially declined with increasing filler fraction, but the resistivity of the nanowire composites remained nearly constant once a certain volume percent was reached (Ag NWs: 11 vol %; 30 μm Cu—Ag NWs: 9 vol %; 50 μm Cu—Ag NWs: 6 vol %). Overall, the 50-μm-long Cu—Ag NW composite had the lowest resistivity across all compositions. Indeed, FIG. 7B shows images of the composite films that exhibit a surface roughness that increases with nanowire concentration, suggesting some degree of aggregation may be occurring. FIG. 7C shows micro-CT images of filament composite films showing areas of high and low density of metal filler. The scale bars of FIGS. 7B and 7C are 1 centimeter.

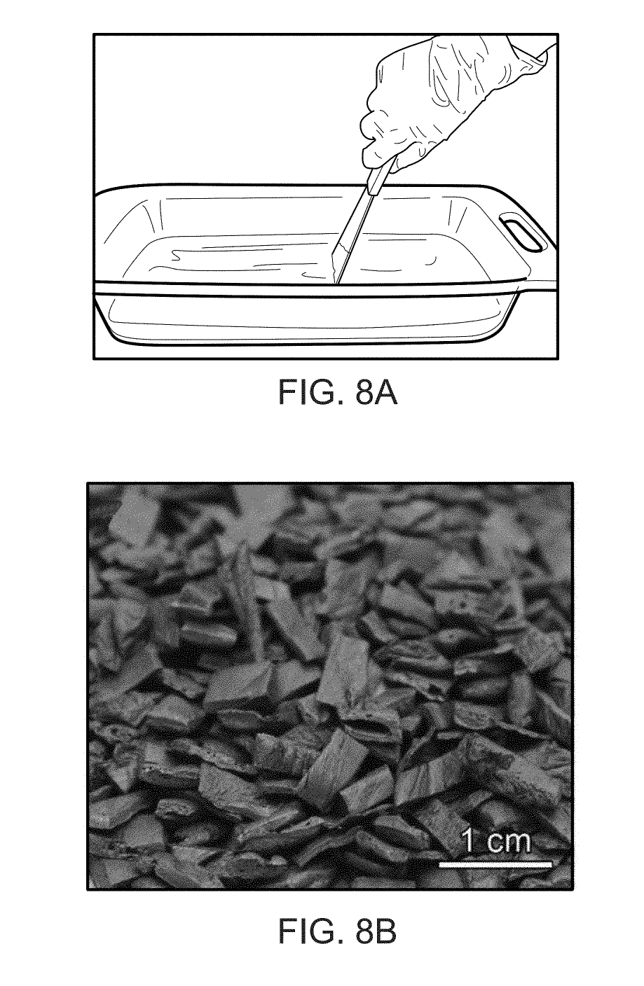

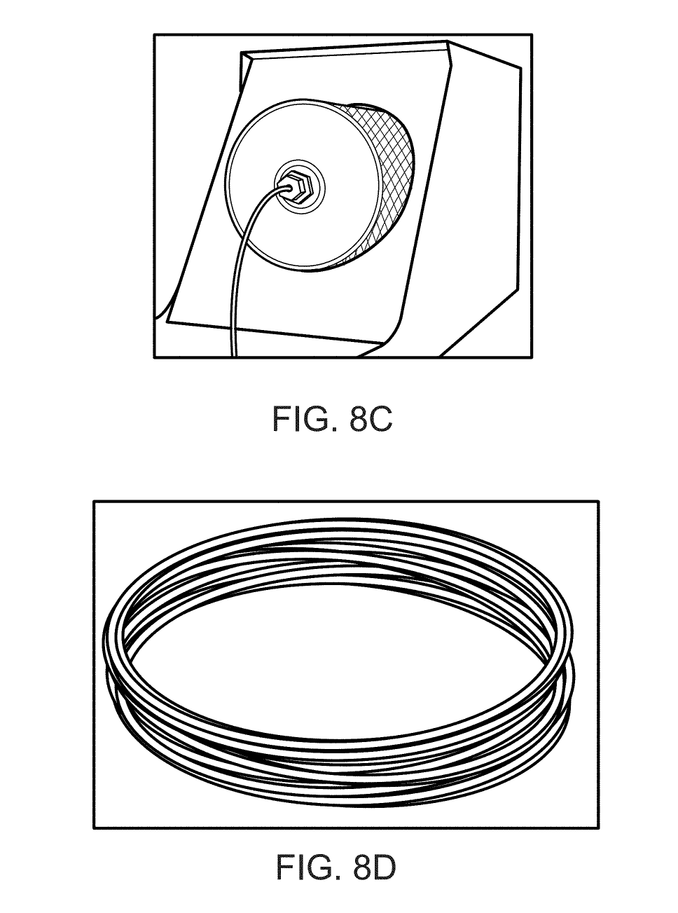

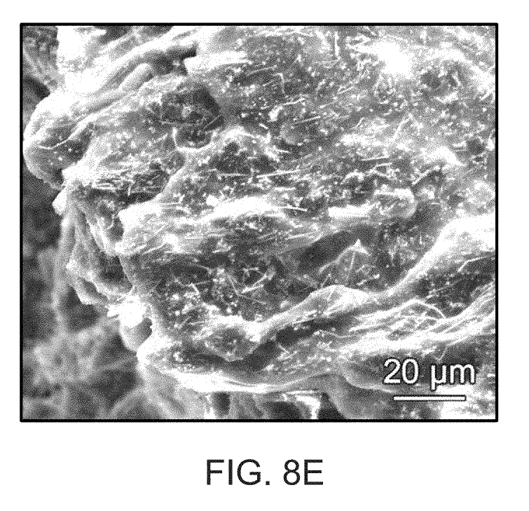

In accordance with embodiments, FIGS. 8A-8D are images showing different example steps in a method of making a conductive filament. In this example, a conductive filament was produced by adding 12 vol % 45-micrometers-long Cu—Ag nanowires (0.10 Ag:Cu mol ratio) to PCL dissolved in dichloromethane (DCM) as shown in FIG. 8A. The DCM was evaporated off completely to form a solid composite. This composite was cut into pellets (see FIG. 8B) and extruded into filament using a Filabot filament extruder (see FIGS. 8C and 8D). An SEM image shown in FIG. 8E suggests that the Cu—Ag nanowires were evenly distributed throughout the filament at this volume fraction and length scale.

One skilled in the art will readily appreciate that the presently disclosed subject matter is well adapted to carry out the objects and obtain the ends and advantages mentioned, as well as those inherent therein. The present examples along with the methods described herein are presently representative of various embodiments, are exemplary, and are not intended as limitations on the scope of the present disclosure. Changes therein and other uses will occur to those skilled in the art which are encompassed within the spirit of the presently disclosed subject matter as defined by the scope of the claims.

What is claimed is:

1. A conductive filament comprising:
a material comprising polymer; and
a plurality of anisotropic conductive particles dispersed within the material.

2. The conductive filament of claim 1, wherein the material is substantially cylindrical in shape.

3. The conductive filament of claim 1, wherein the material has a diameter of between about 0.5 millimeters and 10 millimeters.

4. The conductive filament of claim 1, wherein the conductivity range of the polymer is greater than 10³ Siemens per meter (S/m).

5. The conductive filament of claim 1, wherein a volume fraction of the conductive particles is between about 1% and about 80%.

6. The conductive filament of claim 1, wherein the conductive particles have a uniformity of conductivity within 20% difference per unit length or area.

7. The conductive filament of claim 1, wherein the conductive particles comprise one of nanowires, microwires, flakes, rods, core-shell structures, and dendrites.

8. The conductive filament of claim 1, wherein the conductive particles are made of one of silver, gold, copper, nickel, aluminum, platinum, iron, zinc, and metal alloys and eutectics including alloys of copper, silver, zinc, nickel, gallium, indium, antimony, tin, and lead.

9. The conductive filament of claim 1, wherein the conductive particles comprise metal core-shell structures comprising one of a core metal including one of silver, gold, copper, nickel, aluminum, platinum, iron, zinc, and metal alloys and eutectics including alloys of copper, silver, zinc, nickel, gallium, indium, antimony, tin, and lead, and one of a shell metal including one of silver, gold, copper, nickel, aluminum, platinum, iron, zinc, and metal alloys and eutectics including alloys of copper, silver, zinc, nickel, gallium, indium, antimony, tin, and lead.

10. The conductive filament of claim 1, wherein a size range of a smallest conductive particle among the conductive particles is between about 1 nanometer and about 200 microns.

11. The conductive filament of claim 1, wherein a size range of a largest conductive particle among the conductive particles is between about 100 nanometers and 400 microns.

12. The conductive filament of claim 1, wherein the polymer is one of poly lactic acid, polyethylene terephthalate (PETG), polystyrene, acrylic butyl styrene, nylon, polycarbonates, acrylonitrile styrene acrylate, polycarbonate/acrylonitrile butadiene styrene (PC/ABS), polyetheretherketone (PEEK), polyetherimide, and thermoplastic polymers, glass fiber-reinforced polymer composites, and carbon fiber-reinforced composites.

13. The conductive filament of claim 1, wherein the conductive particles have a silver to copper molecular ratio of between about 0.01 and about 0.5.

14. The conductive filament of claim 1, wherein the conductive particles comprise primary conductive particles and secondary conductive particles, and wherein the secondary conductive particles are smaller than the primary conductive particles.

15. A method for producing conductive filament, the method comprising:
providing a material comprising polymer; and
dispersing a plurality of anisotropic conductive particles within the material.

16. The method of claim 15, wherein the material is substantially cylindrical in shape.

17. The method of claim 15, wherein the material has a diameter of between about 0.5 millimeters and 10 millimeters.

18. The method of claim 15, wherein the conductivity range of the polymer is greater than 10³ siemens per meter (S/m).

19. The method of claim 15, wherein a volume fraction of the conductive particles is between about 1% and about 80%.

20. The method of claim 15, wherein the conductive particles have a uniformity of conductivity within 20% difference per unit length or area.

21. The method of claim 15, wherein the conductive particles comprise one of nanowires, microwires, flakes, rods, core-shell structures, and dendrites.

22. The method of claim 15, wherein the conductive particles are made of one of silver, gold, copper, nickel, aluminum, platinum, iron, zinc, and metal alloys and eutectics including alloys of copper, silver, zinc, nickel, gallium, indium, antimony, tin, and lead.

23. The method of claim 15, wherein the conductive particles comprise metal core-shell structures comprising one of a core metal including one of silver, gold, copper, nickel, aluminum, platinum, iron, zinc, and metal alloys and eutectics including alloys of copper, silver, zinc, nickel, gallium, indium, antimony, tin, and lead, and one of a shell metal including one of silver, gold, copper, nickel, aluminum, platinum, iron, zinc, and metal alloys and eutectics including alloys of copper, silver, zinc, nickel, gallium, indium, antimony, tin, and lead.

24. The method of claim 15, wherein a size range of a smallest conductive particle among the conductive particles is between about 1 nanometer and about 200 microns.

25. The method of claim 15, wherein a size range of a largest conductive particle among the conductive particles is between about 100 nanometers and 400 microns.

26. The method of claim 15, wherein the polymer is one of poly lactic acid, polyethylene terephthalate (PETG), polystyrene, acrylic butyl styrene, nylon, polycarbonates, acrylonitrile styrene acrylate, polycarbonate/acrylonitrile butadiene styrene (PC/ABS), polyetheretherketone (PEEK), polyetherimide, and thermoplastic polymers, glass fiber-reinforced polymer composites, and carbon fiber-reinforced composites.

27. The method of claim 15, wherein the conductive particles have a silver to copper molecular ratio of between about 0.01 and about 0.5.

28. The method of claim 15, wherein the conductive particles comprise primary conductive particles and secondary conductive particles, and wherein the secondary conductive particles are smaller than the primary conductive particles.

29. A method for three-dimensional (3D) printing, the method comprising:
providing a conductive filament comprising a plurality of anisotropic conductive particles dispersed with a polymer material; and
using a 3D printer to deposit portions of the filament in accordance with a predetermined plan for building a conductive structure.

30. The method of claim 29, wherein the material is substantially cylindrical in shape.

31. The method of claim 29, wherein the material has a diameter of between about 0.5 millimeters and 10 millimeters.

32. The method of claim 29, wherein the conductivity range of the polymer is greater than 10³ Siemens per meter (S/m).

33. The method of claim 29, wherein a volume fraction of the conductive particles is between about 1% and about 80%.

34. The method of claim 29, wherein the conductive particles have a uniformity of conductivity within 20% difference per unit length or area.

35. The method of claim 29, wherein the conductive particles comprise one of nanowires, microwires, flakes, rods, core-shell structures, and dendrites.

36. The method of claim 29, wherein the conductive particles are made of one of silver, gold, copper, nickel, aluminum, platinum, iron, zinc, and metal alloys and eutectics including alloys of copper, silver, zinc, nickel, gallium, indium, antimony, tin, and lead.

37. The method of claim 29, wherein the conductive particles comprise metal core-shell structures comprising one of a core metal including one of silver, gold, copper, nickel, aluminum, platinum, iron, zinc, and metal alloys and eutectics including alloys of copper, silver, zinc, nickel, gallium, indium, antimony, tin, and lead, and one of a shell metal including one of silver, gold, copper, nickel, aluminum, platinum, iron, zinc, and metal alloys and eutectics including alloys of copper, silver, zinc, nickel, gallium, indium, antimony, tin, and lead.

38. The method of claim 29, wherein a size range of a smallest conductive particle among the conductive particles is between about 1 nanometer and about 200 microns.

39. The method of claim 29, wherein a size range of a largest conductive particle among the conductive particles is between about 100 nanometers and 400 microns.

40. The method of claim 29, wherein the polymer is one of poly lactic acid, polyethylene terephthalate (PETG), polystyrene, acrylic butyl styrene, nylon, polycarbonates, acrylonitrile styrene acrylate, polycarbonate/acrylonitrile butadiene styrene (PC/ABS), polyetheretherketone (PEEK), polyetherimide, and thermoplastic polymers, glass fiber-reinforced polymer composites, and carbon fiber-reinforced composites.

41. The method of claim 29, wherein the conductive particles have a silver to copper molecular ratio of between about 0.01 and about 0.5.

42. The method of claim 29, wherein the conductive particles comprise primary conductive particles and secondary conductive particles, and wherein the secondary conductive particles are smaller than the primary conductive particles.

43. A method injection molding, the method comprising:
providing a conductive filament comprising a plurality of anisotropic conductive particles dispersed with a polymer material; and
injecting portions of the filament into a mold for forming a conductive structure.
